(19) United States
(12) Patent Application Publication
(10) Pub. No.: US 2017/0197165 A1
(43) Pub. Date: Jul. 13, 2017

(54) FILTER ELEMENT WITH VARIED FILTER MEDIA PACK CHARACTERISTICS

(71) Applicant: CUMMINS FILTRATION IP, INC., Columbus, IN (US)

(72) Inventors: Scott W. SCHWARTZ, Cottage Grove, WI (US); Ken TOFSLAND, Stoughton, WI (US); Brian W. SCHWANDT, Fort Atkinson, WI (US); Barry M. VERDEGAN, Stoughton, WI (US); Mark V. HOLZMANN, Stoughton, WI (US); Peter K. HERMAN, Stoughton, WI (US); Mark A. TERRES, Shakopee, WI (US); Jeremiah J. CUPERY, Madison, WI (US)

(73) Assignee: CUMMINS FILTRATION IP, INC., Columbus, IN (US)

(21) Appl. No.: 15/324,495

(22) PCT Filed: Jul. 21, 2015
(86) PCT No.: PCT/US2015/041357

§ 371 Date: Jan. 6, 2017

Related U.S. Application Data
(60) Provisional application No. 62/029,290, filed on Jul. 25, 2014.

(51) Int. Cl. B01D 46/00; B01D 46/52

(52) U.S. Cl. CPC B01D 46/002; B01D 46/521; B01D 46/525; B01D 46/0023; B01D 46/522; B01D 2275/206

(57) ABSTRACT

A filter element including a first filter media pack with an inlet face and an outlet face and a second filter media pack with an inlet face and an outlet face. The second filter media pack is formed separately from the first filter media pack and is coupled to the first filter media pack such that the respective inlet faces and outlet faces of the first and second media packs do not overlap. The first filter media pack and the second filter media pack each include a corresponding filter media pack characteristic, and the filter media pack characteristic of the first filter media pack is different from the corresponding filter media pack characteristic of the second filter media pack. Exemplary filter media pack characteristics include the length, width, height, shape, media density, layer spacing, pleat bend angle, pleat density, and material composition of the first and second filter media packs.

### CROSS-REFERENCE TO RELATED PATENT APPLICATIONS

This application claims priority to and the benefit of U.S. Provisional Patent Application No. 62/029,290, filed Jul. 25, 2014, the entire disclosure of which is incorporated herein by reference.

### FIELD

The present invention relates generally to filter elements with media packs.

### BACKGROUND

Many compact air filter elements with in-line flow paths have panel filters with pleated media. However, shape flexibility is limited to a standard box shape with generally parallel perimeter walls.

The available space for the filter element (e.g. a vehicle packaging space) for an air induction system is typically very limited and has a complex geometric shape, varying dimensionally at multiple intervals. Due to the geometric constraints within the space surrounding the filter element, the packaging envelopes for the filter elements often have complex geometrical forms. Therefore, it is difficult for the filter element to utilize the entirety of the available space within the packaging envelope due to limited shape flexibility. The shape flexibility is often constrained by the manufacturing equipment and/or processes. For example, modifying the shape of a face of the filter element requires a significant amount of additional manufacturing equipment and process control. Modifying the shape also results in a significant amount of media that is trimmed and scrapped from the filter element, resulting in a large amount of material waste.

For example, the air intake system packaging constraints are particularly challenging with heavy trucks. The top of the engine is relatively parallel to the ground, but the hoodline is sloped to improve the aerodynamics, resulting in a trapezoidal space between the engine and the underside of the hood that is available for air filter packaging. If the face shape of the air element is circular, obround, or rectangular, for example, the space is not fully utilized.

Although some filters contain tapered walls, they require significant open areas void of media to allow for air flow. Air filter restriction affects fuel efficiency and even small, incremental performance improvements within the available space constraints can be beneficial and are of interest to vehicle original equipment manufacturers (OEM).

### SUMMARY

Various embodiments provide for a filter element including a first filter media pack with a first filter media pack inlet face and a first filter media pack outlet face and a second filter media pack with a second filter media pack inlet face and a second filter media pack outlet face. The second filter media pack is formed separately from the first filter media pack and is coupled to the first filter media pack such that the first filter media pack inlet face and the first filter media pack outlet face of the first media pack do not overlap with the second filter media pack inlet face and the second filter media pack outlet face of the second media pack, respectively. The first filter media pack and the second filter media pack each include a corresponding filter media pack characteristic, and the filter media pack characteristic of the first filter media pack is different from the corresponding filter media pack characteristic of the second filter media pack. Exemplary filter media pack characteristics include the length, width, height, shape, media density, layer spacing, pleat bend angle, pleat density, and material composition of the first and second filter media packs.

Various other embodiments provide for a filter element configured to filter a fluid that includes a first filter media pack with a first filter media pack inlet face, a first filter media pack outlet face, and at least one first filter media pack side face extending between the first filter media pack inlet face and the first filter media pack outlet face, and a second filter media pack with a second filter media pack inlet face, a second filter media pack outlet face, and at least one second filter media pack side face extending between the second filter media pack inlet face and the second filter media pack outlet face. The first filter media pack defines a first flow path and the second filter media pack defines a second flow path. The first filter media pack and the second filter media pack are formed separately from each other and coupled together such that the at least one first filter media pack side face is positioned next to the at least one second filter media pack side face and the first flow path is not aligned with the second flow path.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a perspective view of a filter element according to one embodiment.

FIG. 2 is a perspective view of a filter element according to another embodiment.

FIG. 3 is a perspective view of media packs that may be used within the filter element of FIG. 1.

FIGS. 4A-4H are perspective views of filter elements according to various embodiments.

FIG. 5 is a perspective view of a filter element according to another embodiment.

FIG. 6 is a perspective view of a filter element according to yet another embodiment.

FIG. 7 is a perspective view of a filter element according to still another embodiment.

FIGS. 8A-8B are exploded-perspective and perspective views, respectively, of a filter element according to yet another embodiment.

FIGS. 9A-9C are perspective, exploded, and cross-sectional views of a filter element according to another embodiment.

FIG. 10 is a perspective view of a filter element according to still another embodiment.

FIGS. 11A-11B are perspective views of filter elements according to various embodiments.

FIGS. 12A-12B are perspective views of filter media in two different media packs according to various embodiments.

FIG. 13 is a perspective view of filter media in a media pack according to another embodiment.

### DETAILED DESCRIPTION

Referring to the figures generally, the various embodiments disclosed herein relate to a filter element, such as an air filter, with at least two individual filter media packs each with filter media pack characteristics. At least one corresponding filter media pack characteristic may be different between the individual media packs. The filter media pack characteristics may include, for example, media density, pleat density, layer spacing, or dimensions of the media packs. Certain filter media pack characteristics may optionally be optimized according to, for example, the dimensions (e.g., the length, width and/or height) of the respective media pack.

The media packs may be arranged or positioned together into any overall shape of the filter element, such as in a trapezoid, according to the desired configuration. By arranging and joining at least two media packs with different filter media pack characteristics (e.g., different sizes), a unique filter element shape may be created. Accordingly, the filter element may be specifically designed to fit within a defined space, which may be defined by the customer/original equipment manufacturer of a vehicle or engine system and may be an irregular or complex shape.

The filter element, as described further herein, may therefore have a high degree of shape flexibility, and the entire area or space available for air filter packaging of the filter element may be utilized to provide a better-performing product. Accordingly, the shape of the filter element may directly correspond to and thus may maximize the available space for the filter. Accordingly, the filter element may also provide a larger or maximized flow area within this available space to reduce the air flow restriction to the engine and increase the service life of the filter element. Further, by allowing the filter element to be in any shape, the filter element may be easily manufactured with no or minimal material waste.

According to one embodiment, the filter element may include at least two sub-components or media packs in a side-by-side configuration which may filter the flow of air or liquid moving through the filter element. The media packs may have different media pack characteristics. For example, the media packs may have different sizes, e.g., different lengths, widths or height, in order to correspond with the available space for the filter element. The media packs may also have different media densities within each of the media packs to adjust for the size differences between the media packs and to even out the flow. The media packs in some embodiments may also utilize difference types of filter media.

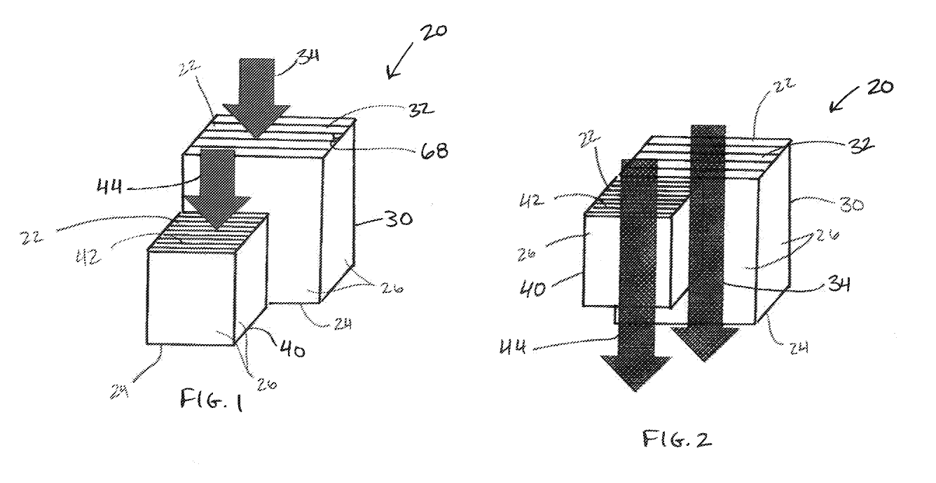

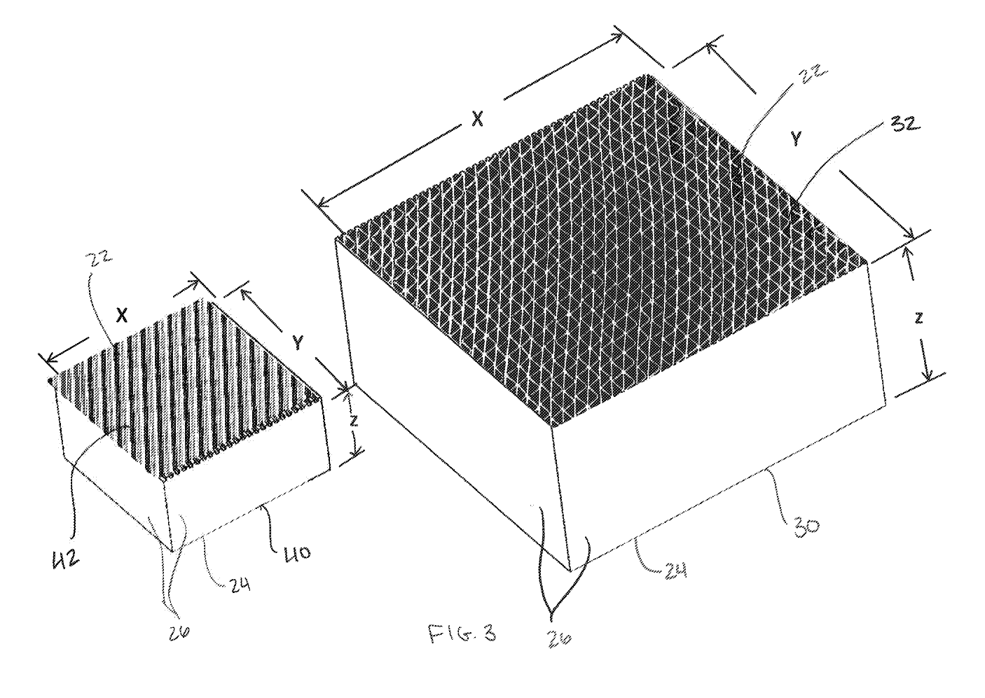

Referring to FIGS. 1-2, there is shown a filter element 20 including individual sub-elements, media blocks, or media packs of different sizes to best utilize the available package space for the filter element 20. The media packs may be attached, coupled, or joined together to form a single pack or element (e.g., the filter element 20).

### First and Second Filter Media Packs

As shown in FIGS. 1-2, the filter element 20 includes a first filter media pack 30 and a second filter media pack 40. The first and second media packs 30 and 40 may be formed separately from each other and may be coupled to each other within the filter element 20. As described further herein, the first and second media packs 30 and 40 each have individual filter media pack characteristics (including, but not limited to, size (e.g., length, width, height), shape (e.g., the individual outer shapes of each of the first and second media packs 30 and 40), media density, layer spacing, material composition (e.g., type of media), pleat bend angle, and pleat density). At least one of the filter media pack characteristics of the first media pack 30 is different than the corresponding filter media pack characteristic of the second media pack 40.

As shown in FIGS. 1-2, the first and second media packs 30 and 40 each include inlets and outlets that are defined by the flow paths through each of the first and second media packs 30 and 40. The first and second media packs 30 and 40 may include flow surfaces, such as an inlet face 22 and an outlet face 24. For example, the first media pack 30 and the second media pack 40 each include an upstream face, inlet end, or inlet face 22 that the fluid may flow through (along a flow path) to enter into one of the first media pack 30 and the second media pack 40. The first media pack 30 and the second media pack 40 also each include a downstream face outlet end or face 24 that the fluid may flow through to exit out from one of the first media pack 30 and the second media pack 40. Although the inlet face 22 and the outlet face 24 are referred to herein and shown as an inlet and an outlet, respectively, it is understood that the inlet face 22 may correspond to an outlet and the outlet face 24 may refer to an inlet.

The first media pack 30 and the second media pack 40 each further include at least one side surface or face 26 that may connect or extend between the inlet face 22 and the outlet face 24. The side face 26 may be substantially parallel to the direction of flow through the first media pack 30 or the second media pack 40. Depending on the configuration of the first and second media packs 30 and 40, the first and second media packs 30 and 40 may either prevent or allow fluid to flow through the side faces 26. The first and second media packs 30 and 40 may be coupled together such that the respective side faces 26 of the first and second media packs 30 and 40 are positioned next to or alongside each other (e.g., along the heights of the side faces 26 and the heights of the first and second media packs 30 and 40) and the respective inlet faces 22 and outlet faces 24 of each of the first and second media packs 30 and 40 do not overlap or cover each other.

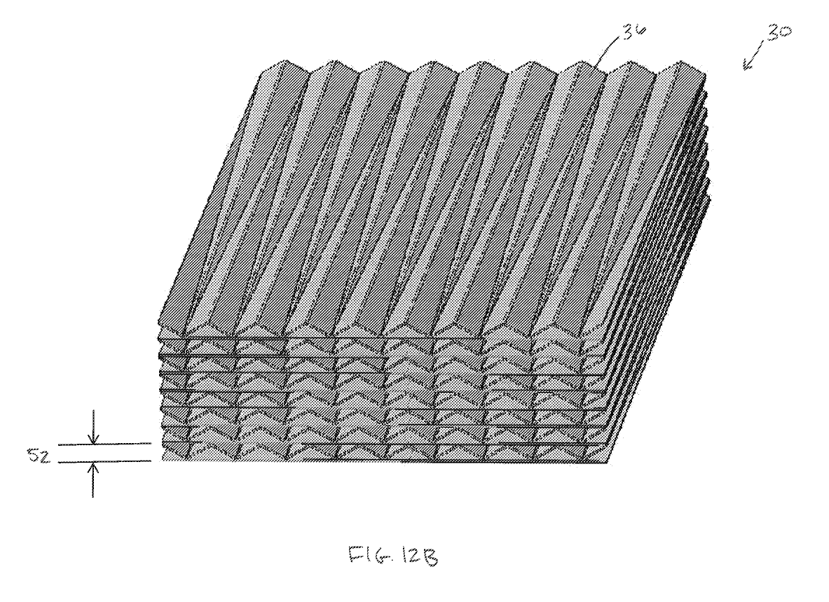

The first media pack 30 includes first filter media 32, and the second media pack 40 includes second filter media 42 to filter the air or other fluid flowing through the filter element 20. The respective first and second filter media 32 and 42 may be pleated, tetrahedral, fluted, corrugated, and/or coiled packs of filter media. The respective first and second filter media 32 and 42 may be, for example, tetrahedral air filter media as described in U.S. Pat. No. 8,397,920 (the contents of which are incorporated herein by reference) and as shown in FIG. 12B. Such filter media extends axially between an upstream inlet and a downstream outlet along a plurality of axially extending bend lines forming axial flow channels. The bend lines define a plurality of axially elongated tetrahedron channels facing oppositely to each other.

More specifically describing the filter media depicted in FIG. 12B, the bend lines comprise a first set of bend lines extending from the upstream inlet axially towards the downstream outlet, and a second set of bend lines extending from the downstream outlet axially towards the upstream inlet. A plurality of wall segments extend in serpentine manner between the bend lines, with the wall segments extending axially and defining the axial elongated tetrahedron channels therebetween. The axial elongated tetrahedron channels have a height along the transverse direction, the transverse direction being perpendicular to the axial direction. The axial elongated tetrahedron channels also have a lateral width along a lateral direction, the lateral direction being perpendicular to the axial direction and perpendicular to the transverse direction. At least some of the bend lines taper in the transverse direction as they extend axially in the axial direction.

The wall segments extending in a serpentine manner define a laterally extending serpentine span comprising a first wall segment laterally adjacent a second wall segment and joined thereto by a first bend line and continuing in the serpentine manner along the serpentine span to a third wall segment laterally adjacent the second wall segment and joined thereto by a second bend line. This arrangement continues along the serpentine span. The serpentine span extends along the lateral direction, such that the taper of the bend lines tapering in the transverse direction is perpendicular to the serpentine span along the lateral direction.

The wall segments comprise a first set of wall segments alternately sealed to each other at the upstream inlet to define a first set of channels having open upstream ends, a second set of channels interdigitated with the first set of channels and having closed upstream ends, a second set of wall segments alternately sealed to each other at the downstream outlet to define a third set of channels having closed downstream ends, and a fourth set of channels interdigitated with the third set of channels and having open downstream ends. The first set of bend lines comprises a first subset of bend lines defining the first set of channels, and a second subset of bend lines defining the second set of channels. The second subset of bend lines taper in the transverse direction as they extend from the upstream inlet axially towards the downstream outlet. The second set of bend lines comprises a third subset of bend lines defining the third set of channels, and a fourth subset of bend lines defining the fourth set of channels. The fourth subset of bend lines taper in the transverse direction as they extend from the downstream outlet axially towards the upstream inlet.

Alternatively or additionally to the tetrahedral filter media described above and depicted in FIG. 12B, the respective first and second filter media 32 and 42 may also be fluted in other implementations. The orientation of the pleats, flutes, corrugations, etc. may be different in the first and second filter media 32 and 42 in particular embodiments.

Air or other fluid flows through the filter element 20 to be filtered by at least one of the first and second filter media 32 and 42 within the first and second media packs 30 and 40. As shown in FIGS. 1-2, the fluid may flow along the direction of first flow path 34 defined by and through the first media pack 30 and/or along the direction of second flow path 44 defined by and through the second media pack 40. Due to the relative positioning of the first and second media packs 30 and 40, the first and second flow paths 34 and 44 are not aligned with each other. The first and second flow paths 34 and 44 may originate from and/or end as the same path or different paths.

In the embodiments shown in FIGS. 1-2, the first and second flow paths 34 and 44 are parallel to each other. However, in other implementations, the first and second flow paths 34 and 44 may not be parallel to each other, and one of the flow paths may be at a different angle or direction from the other flow path, depending on the relative positioning of the first and second media packs 30 and 40.

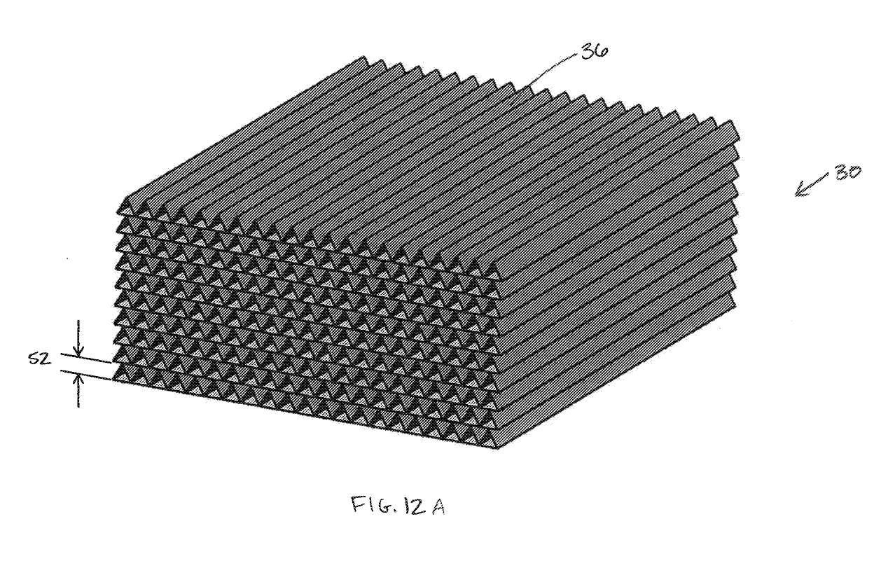

Additionally, there may be only one flow path or more than two flow paths according to the quantity and relative configuration of the media packs. For example, according to one embodiment as shown in FIG. 11A, different fluid may flow simultaneously and separately through each of the first and second media packs 30 and 40 along the first and second flow paths 34 and 44, respectively. According to another embodiment as shown in FIG. 11B, the fluid may from through the first media pack 30 along the first flow path 34, may change direction, and may subsequently continue to flow through the second media pack 40 along the second flow path 44.

### Filter Media Pack Characteristics

At least one of the filter media pack characteristics of each of the first and second media packs 30 and 40 may be different from a corresponding filter media pack characteristic of the other of the first and second media packs 30 and 40, according to the configuration of the filter element 20. The filter media pack characteristics include, but are not limited to, the media density, the pleat density, the pleat pitch (e.g., the pleat bend angle, the pleat angle, or the layer thickness), the filter media angle, the material composition, the individual shape, the individual sizes, the layer spacing, the radii shape, the circumference of the first and second media packs 30 and 40 (when in a coiled or wound configuration), and/or other characteristics of the respective first and second filter media 32 and 42. The various potential configurations and combinations of different first and second media packs 30 and 40 may optimize the filter element 20 according to the desired shape and size of the filter element 20 in order to provide a high-performance filter element.

The media pack characteristics may be determined by the desired use of the filter element and/or may depend on other media pack characteristics (e.g., the media density may depend on the size of the media pack). Accordingly, the individual media pack characteristics of each of the first and second media packs 30 and 40 may be unique from each other and may be selected to provide optimal performance and/or functionality for the entire filter element 20 within the given volume. For example, by changing the media density according to the relative size of the media pack, the individual first and second media packs 30 and 40 may load at the same rate, regardless of their relative sizing.

The media density (e.g., the media packing density) may be defined by the number of layers of filter media per unit distance and may depend on layer thickness 52, as shown with the media 36 in FIG. 12A. More specifically, media density may be calculated by:

$$Media Density = \frac{ Number of Layers}{Thickness of the layers } = \frac{1}{Layer Thickness}$$

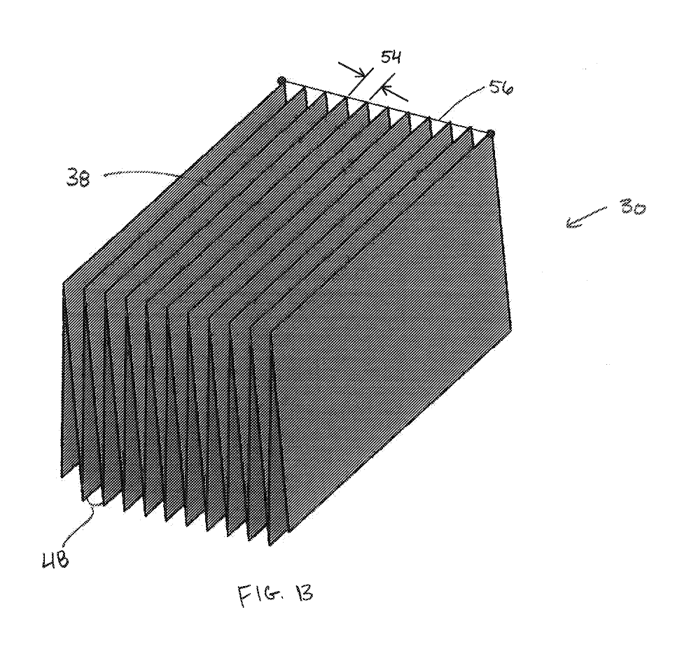

The pleat density may depend on the pleat spacing 54 and the length 56 of the pleated media 38, as shown in FIG. 13. More specifically, pleat density may be calculated by:

$$Pleat Density = \frac{Number of Pleats}{Length} = \frac{1}{Pleat Spacing}$$

As shown in FIG. 13, the first and second media packs 30 and 40 may also be optimized with respect to the pleat bend angle 48, which is the angle between the pleats of the filter media or pleated media 38. If the pleat bend angle 48 is smaller, the pleats may be closer together.

The filter media angle 68 may refer to the angle of the first and second filter media 32 and 42 relative to the outer edge of the first and second media packs 30 and 40, respectively, may be shown in, for example, FIG. 1, and may vary according to the desired configuration.

The material composition (e.g., the type of filter media) of each of the first and second media packs 30 and 40 may be different depending on the desired configuration of the filter element 20 and the relative sizes of the first and second media packs 30 and 40. For example, the first filter media 32 and the second filter media 42 may be different types of filter media or material. According to one embodiment, the first filter media 32 and the second filter media 42 may each be a polymer with a different fiber diameter and/or pore size.

The shape and size of the first and second media packs 30 and 40 may depend on the dimensions and shape of the available space for the entire filter element 20 in order to allow the filter element 20 to utilize and fit within the entire available package space. Accordingly, the shape and size of the first media pack 30 may be different than the shape and size of the second media pack 40 within the same filter element 20.

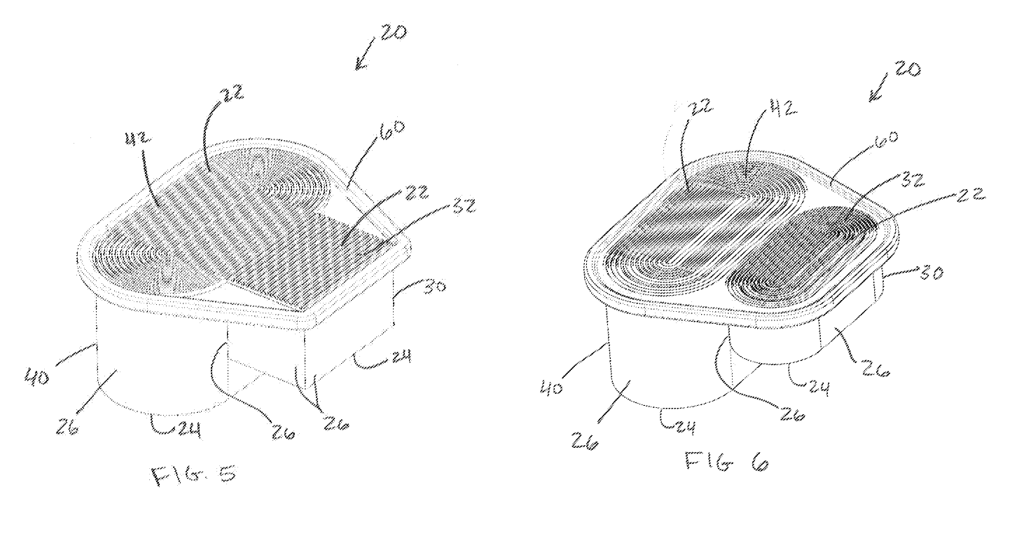

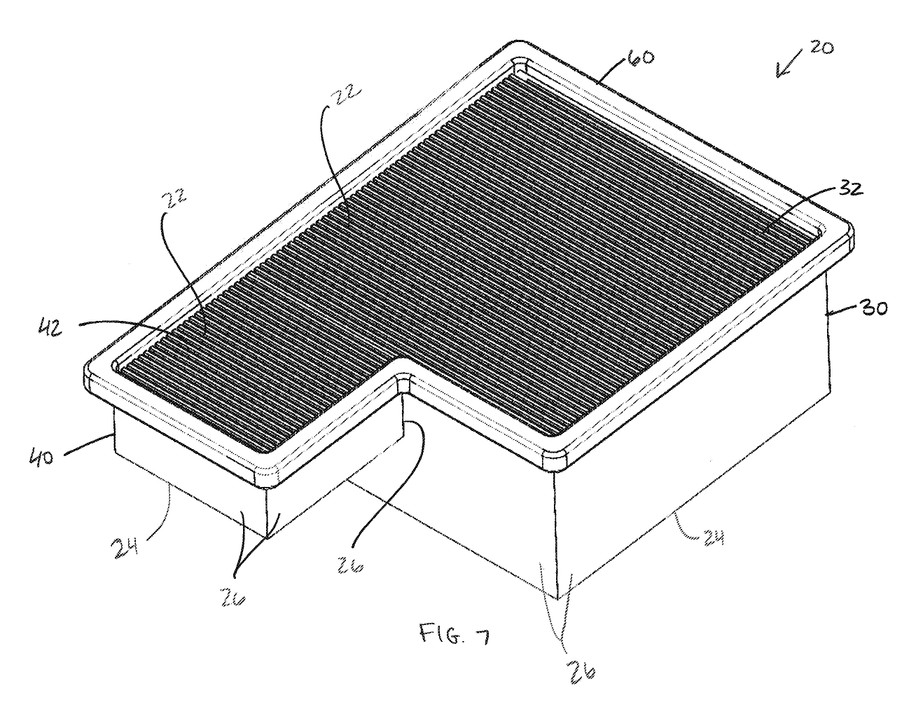

The individual shapes of the first and second filter media 32 and 42 may be different or the same, depending on the desired configuration of the filter element 20. The shape of each of the first media pack 30 and the second media pack 40 may refer to the outer shape and/or the inner shape of each of the first media pack 30 and the second media pack 40. The first and second filter media 32 and 42 may be arranged into any individual shape to form each of the first and second media packs 30 and 40, respectively. For example, the first and second media packs 30 and 40 may have a variety of three-dimensional shapes including, but not limited to a box, cylinder, oval, circular, obround, pyramid, prism, or polyhedral shapes. As shown in FIG. 1, at least one of the first filter media 32 and second filter media 42 may be approximately formed as a rectangular prism, a box shape, or a “block.” According to another embodiment, the first and second filter media 32 and 42 may be cut into individual layers and sealed into a box-shaped first media pack 30 or second media pack 40. The first and second filter media 32 and 42 may be constrained to maintain the desired configuration of the first and second media packs 30 and 40. According to yet another embodiment as shown in FIGS. 5-6, one or both of the first and second filter media 32 and 42 may be wound or coiled into a shape that has a circular, oblong, or oval cross-section.

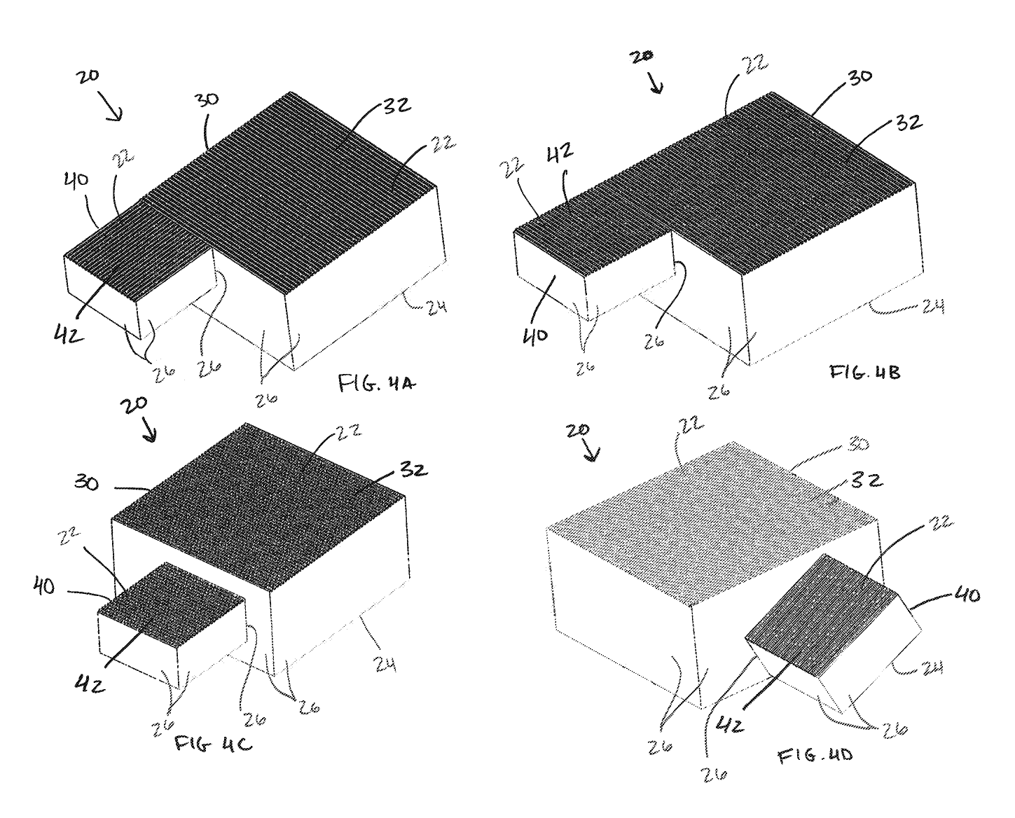

The individual sizes or dimensions of the first and second media packs 30 and 40 may be characterized by the length, width, and height along the x, y, and z axes, respectively, as shown in FIG. 3. The first and second media packs 30 and 40 may have any size ratio in relation to each other along the x, y, and z axes. Accordingly, the first and second media packs 30 and 40 (and the filter element 20) may be dimensionally flexible according to available space for the filter element 20. As shown in FIG. 3, the second media pack 40 may serve as a sub-filter with smaller dimensions in multiple directions, while the first media pack 30 may be the larger main filter block.

The dimension along the x-axis may correspond to the width, the dimension along the y-axis may correspond to the length, and the dimension along the z-axis may correspond to the height of the first and second media packs 30 and 40. The width and length may correspond to the size (e.g., the cross-sectional area) of the each of the inlet and outlet faces 22 and 24 of each of the filter media packs 30 and 40. The height (e.g., the height dimension) of each of the first and second media packs 30 and 40 may correspond to the distance that the flow paths 34 and 44 flows through each of the first and second media packs 30 and 40 (e.g., the distance from the inlet face 22 to the outlet face 24) and thus the heights of the side faces 26 of first and second media packs 30 and 40.

The sizes of the first and second media packs 30 and 40 may vary from each other along the x-axis, the y-axis, and/or the z-axis, while the filter element 20 may still maintain an even or substantially even flow distribution. In order to improve performance and equalize the flow between the first and second media packs 30 and 40, the media packing (e.g., the media density, layer spacing, or pleat density) of each of the first and second media packs 30 and 40 may be unique and individually optimized or tailored according to the specific relative media pack characteristics (e.g., the relative shape and size) of that individual media pack compared to the other media pack(s). Accordingly, the media and/or pleat density of the first media pack 30 may be different than the media and/or pleat density of the second media pack 40 within the same filter element 20, in particular if the first and second media packs 30 and 40 are different sizes.

For example, for any given media layer spacing, flow may be restricted as the height (e.g., the height dimension, which corresponds to the flow path distance of fluid flowing through one of the media packs) of the media pack increases due to the increase in viscous drag in higher or taller media packs. The increase in viscous drag needs to be offset by a decrease in media density (e.g. larger filter media spacing). Therefore, the layer spacing of one of the media packs may be increased (thus decreasing or lowering the media density) as the height of the media pack increases or is higher in order to offset the increased flow restriction. In order to optimize a media pack with a relatively shorter height, the pleat density may be increased by using smaller or tighter pleat or filter media spacing, smaller flute dimensions, or a smaller pleat gap (compared to a media pack with a relatively longer media depth). Accordingly, the media pack may be optimized to maximize the dust holding capacity and to minimize the pressure drop. With variable layer spacing, the filter element 20 can provide an even flow and optimal performance. Otherwise, the performance of the filter element 20 may not be optimal since the air flow may migrate toward one or the other media pack (assuming all of the media packs used within the filter element 20 are constructed using the same dimensional spacing (e.g., media density) of each layer), which may cause uneven dust loading and sub-optimal performance, especially when the media packs have significant differences in height.

As represented in FIGS. 1 and 2, for example, the second filter media pack 40 may be smaller (e.g., a smaller height) than the second filter media pack 30. Accordingly, the second filter media 42 may be more densely arranged within the second media pack 40 than the first filter media 32 within the first media pack 30 in order to provide an even flow between the two media packs 30 and 40. According to one embodiment, the first filter media 32 may have approximately a 3.2 mm layer spacing and the second filter media 42 may have approximately a 2.8 mm layer spacing in order to provide optimal flow between the first and second media packs 30 and 40 as well as a maximized total dust holding capacity at some defined termination pressure drop level.

According to another embodiment, the first and second media packs 30 and 40 may have equal sizes or the same dimensions (e.g., spatial envelope), but may differ in other filter media pack characteristics (including, but not limited to media density, pleat density, or type of media). According to one embodiment, only one of the dimensions (e.g., length, width, or height) may be the same between the first and second media packs 30 and 40, while the other dimensions may be different.

### The First and Second Media Packs Attached Together

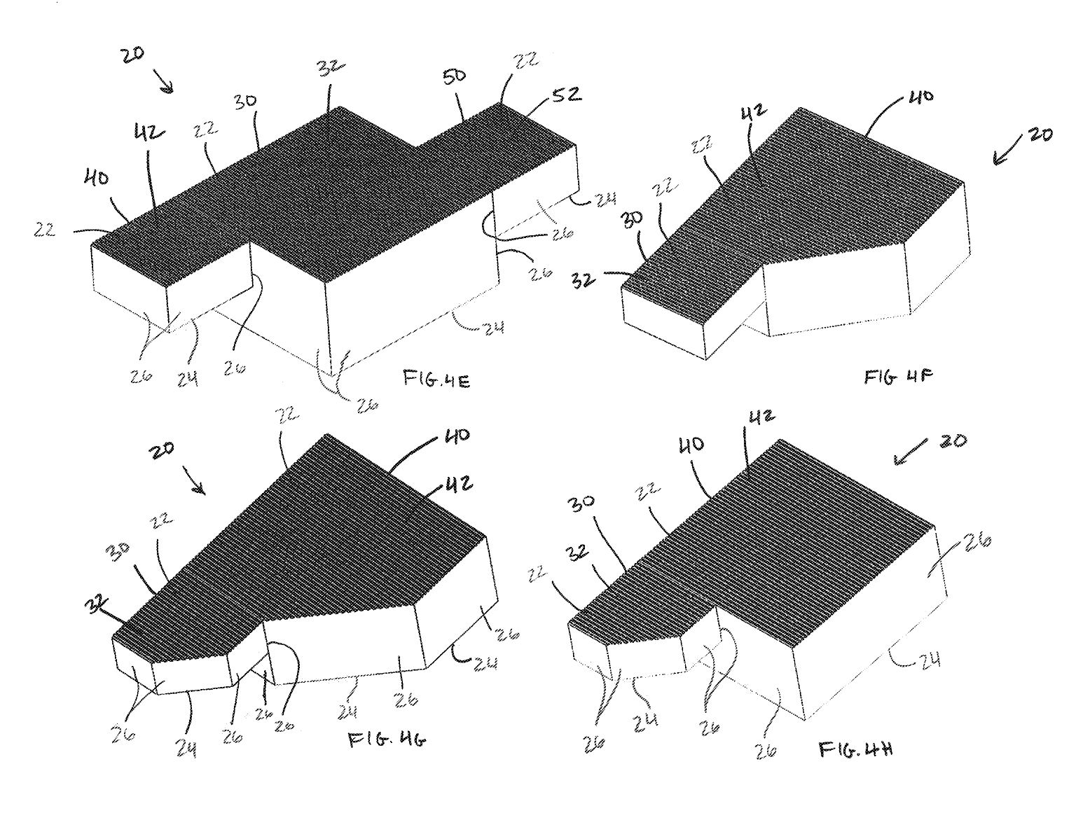

The first and second media packs 30 and 40 may be combined to create a single filter element 20. As shown in FIGS. 4A-4H, the first and second media packs 30 and 40 may be layered or arranged and joined, coupled, attached, or otherwise physically connected to each other in order to form the single structure of the filter element 20. Accordingly, there may be a transition within the filter element 20 between the characteristics of the first media pack 30 to the characteristics of the second media pack 40. The first and second media packs 30 and 40 may be permanently attached through a variety of different methods, including but not limited to mechanical or chemical attachments. According to one embodiment as described further herein, a side face 26 of the first media pack 30 may be adjacent to, next to, or attached to a side face 26 of the second media pack 40.

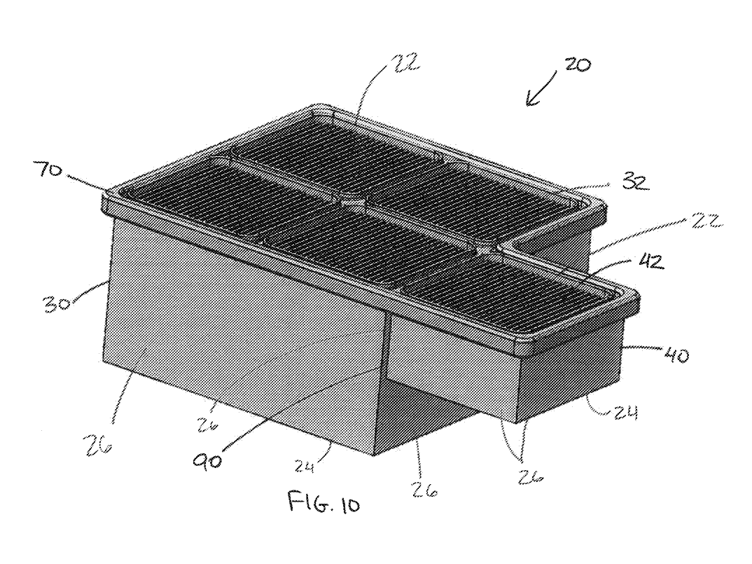

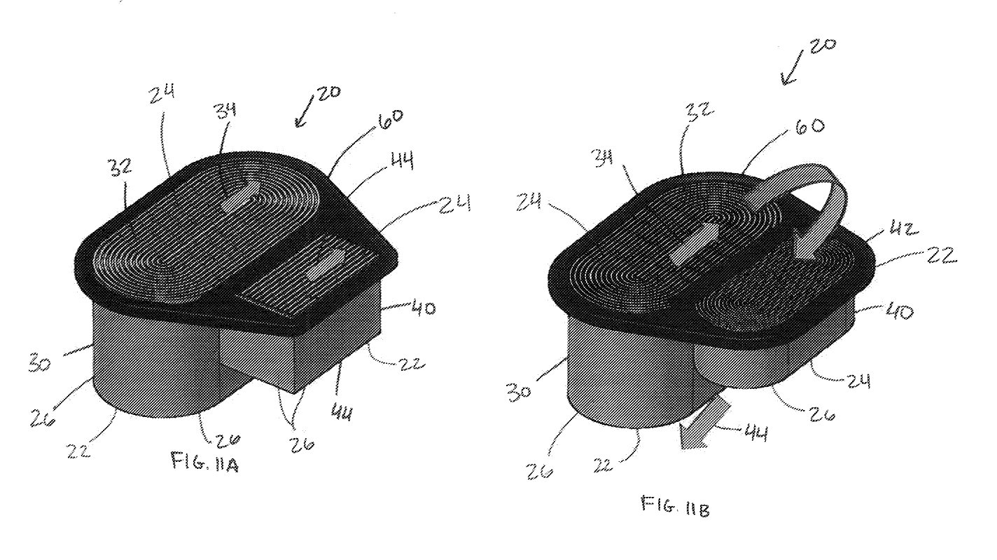

According to one embodiment as shown in FIG. 9C, the side faces 26 of the first and second media packs 30 and 40 may be directly attached to and may directly abut each other. According to another embodiment as shown in FIG. 10, the first and second media packs 30 and 40 may not be directly attached or may not abut each other, as there may be a small space, separation, or gap 90 between the first and second media packs 30 and 40 (e.g., between the respective side faces 26 of the first and second media packs 30 and 40). Instead, a rim, seal 60, or frame 70 may attach, couple, or connect the first and second media packs 30 and 40. The frame 70 may prevent the fluid from flowing through a separate flow passage (e.g., circumventing the first and second media packs 30 and 40) and may optionally also extend along the inlet face 22, the outlet face 24, and/or the side face 26 of the first media pack 30 and/or the second media pack 40.

The first and second media packs 30 and 40 may be arranged into any overall shape in order to best fit into the available space for the filter element 20, thereby creating a unique or custom filter element 20 shape. The spatial positions between the first and second media packs 30 and 40 are not constrained except that the first and second media packs 30 and 40 are joined or coupled to each other, directly or indirectly. According to one embodiment, the first and second media packs 30 and 40 may not encompass, enclose, or otherwise contain the other media pack.

FIGS. 4A-4H, 5, and 6 show a variety of exemplary arrangements between the first and second media packs 30 and 40 to create the filter element 20. The first filter media 32 and the second filter media 42 may be arranged at any angle relative to each other. As shown in FIG. 4A, the second media pack 40 may be attached to the first media pack 30 such that the pleated, fluted, or tetrahedron layer of the second filter media 42 of the second media pack 40 is perpendicular to that of the first filter media 32 of the first media pack 30 and along the same plane (e.g., the respective inlet face 22 and/or the outlet face 24 of the first and second filter media 30 and 40 may be aligned along the same plane or level). However, as shown in FIG. 4B, the pleated, fluted, or tetrahedron layer of the second filter media 42 may be parallel to that of the first filter media 32 and along the same plane. It is also anticipated that the first and second filter media 32 and 42 may be angled relative to each other along the x, y, and/or z axes. As described further herein and according to one embodiment, the first and second media packs 30 and 40 may have at least one different filter media pack characteristic from each other.

The first and second media packs 30 and 40 may be positioned next to each other along their respective side faces 26 in any relative orientation and may further optionally be directly attached to each other through their respective side faces 26. The second media pack 40 may be attached to or positioned relative to any surface of the first media pack 30, such as the inlet face 22, the outlet face 24, and/or any of the side faces 26. Accordingly, the inlet faces 22 and/or the outlet faces 24 of the first and second media packs 30 and 40 may be parallel or angled relative to each other. Alternatively or additionally, the first and second media packs 30 and 40 may be attached together with or through the filter element frame 70 or the seal 60.

According to one embodiment as shown in FIG. 4C, a side face 26 of the first media pack 30 may be attached to or positioned by a side face 26 of the second media pack 40 (e.g., in a side-by-side configuration) and the flow surfaces (e.g., the inlet faces 22 and/or the outlet faces 24) may be parallel to each other. The inlet faces 22 and/or the outlet faces 24 of each of the first and second media packs 30 and 40 may be positioned along different planes from each other.

According to another embodiment as shown in FIG. 4D, however, a side face 26 of the first media pack 30 may be attached to or positioned by a side face 26 of the second media pack 40 and the flow surfaces (e.g., the inlet faces 22 and/or the outlet faces 24) may be angled relative to each other.

According to yet another embodiment, multiple media packs with different lengths, heights, and/or widths may be layered on top of each other to create a total inlet face area that is larger or smaller than the total outlet face area, resulting in a tapered perimeter on the media pack. For example, the inlet face 22 of the second media pack 40 may be attached to the outlet face 24 of the first media pack 30 such that the first and second media packs 30 and 40 are stacked on each other. The inlet faces 22 and/or the outlet faces 24 of the first and second media packs 30 and 40 may have different cross-sectional areas.

Any number of media packs may be used within the filter element 20. As shown in FIGS. 1 and 2, two media packs (e.g., the first and second media packs 30 and 40) are joined together to form the filter element 20. As the number of media packs within the filter element 20 increases, the complexity of the shape of the filter element 20 may also increase. It is understood that the filter element 20 may include three, four, five, or more media packs assembled into the one filter element 20.

As shown in FIG. 4E, three media packs 30, 40, and 50 are joined to form the filter element 20. The additional third filter media pack 50 is formed separately from the first and second media packs 30 and 40 and may be attached or coupled to the first media pack 30 and/or the second media pack 40. The third media pack 50 may defined a third flow path that is not aligned with the first or second flow paths 34 or 44. The third media pack 50 may also have at least one different filter media pack characteristic that is different than a corresponding filter media pack characteristic of the first media pack 30 and/or that of the second media pack 40. For example, the third media pack 50 may have different dimensions than the first media pack 30 and/or the second media pack 40 and/or may have filter media 52 with different characteristics than that of the first filter media 32 and 42.

The individual shapes of the first and second media packs 30 and 40 (which may be identical or different from each other) may also change the overall shape of the filter element 20. For example, according to one embodiment as shown in FIG. 4F, the first media pack 30 is a rectangular prism (e.g., the inlet face 22 and the outlet face 24 have a rectangular cross-section) and the second media pack 40 has a tapered shape (e.g., the inlet face 22 and the outlet face 24 have a rectangular cross-section with a tapered corner or side). According to another embodiment as shown in FIG. 4G, both of the first and second media packs 30 and 40 have tapered shapes. According to yet another embodiment as shown in FIG. 4H, for example, the first media pack 30 has a tapered shape and the second media pack 40 is a rectangular prism. According to yet another embodiment as shown in FIG. 5, the second media pack 40 has an obround-shaped (e.g., the inlet face 22 and the outlet face 24 have an oblong, circular, or oval cross-section), while the first media pack 30 is a rectangular prism. According to yet another embodiment as shown in FIG. 6, each of the first and second media packs 30 and 40 are both obround-shaped but may each have different dimensions, with the first and second media packs 30 and 40 being positioned a side-by-side configuration (e.g., the side faces 26 are adjacent or next to each other), with the respective winding axes being parallel to each other. However, it is anticipated that a wide variety of other combinations of shapes may be used to create the desired overall shape of the filter element 20. In each of the configurations, the flow paths 34 and 44 may run alongside each other and may be parallel to each other such that the first and second media packs 30 and 40 may filter in tandem. Alternatively, one of the flow paths 34 or 44 may flow into the other flow path 34 or 44 such that the first and second media packs 30 and 40 filter sequentially.

### The Seal

According to one embodiment as shown in FIGS. 5-8B, the filter element 20 may include one or more seals 60. The seal(s) 60 may serve to isolate the upstream and downstream portions of the fluid or air to be filtered, and/or to isolate the flow through the first media pack 30 from the flow through the second media pack 40. The seal 60 may encompass or extend around at least a portion of the perimeter of the assembled first and second media packs 30 and 40 (e.g. around the entire filter element 20 or a portion of the filter element 20).

The seal 60 may be an integral radial or axial seal and may be constructed out of a variety of different materials. For example, the seal may be an elastomeric or polyurethane seal. A polyurethane seal, for example, may be modeled around the perimeter of any unique shape of the filter element 20 with known manufacturing processes.

According to one embodiment, the seal 60 may extend along or across a line, seam, or portion joining the first and second media packs 30 and 40 in order to separate the flow of fluid into at least two different flow paths 34 and 44. For example, according to one embodiment as shown in FIG. 11A, the seal 60 may compartmentalize the filter element 20 by separating the first media pack 30 and the second media pack 40. Accordingly, the first and second flow paths 34 and 44 may be separated between air and crankcase ventilation (CV) functions. For example, air may flow through the first media pack 30 while crankcase ventilation may concurrently flow through the second media pack 40 in tandem.

According to another embodiment as shown in FIG. 11B, the seal 60 may be used to direct the fluid flow between the first and second media packs 30 and 40. For example, the fluid may flow through the first media pack 30 along the first flow path 34 in one direction (stage 1), the fluid flow may reverse or change directions (due to, for example, a housing or shell surrounding the first and second filter media 30 and 40), and then the fluid may continue to flow through the second media pack 40 along the second flow path 44 in another direction (stage 2). The first flow path 34 may flow into the second flow path 44 and the first and second flow paths 34 and 44 may flow in substantially opposite directions. Accordingly, the fluid may be filtered twice by flowing once through the first media pack 30 and once through the second media pack 40.

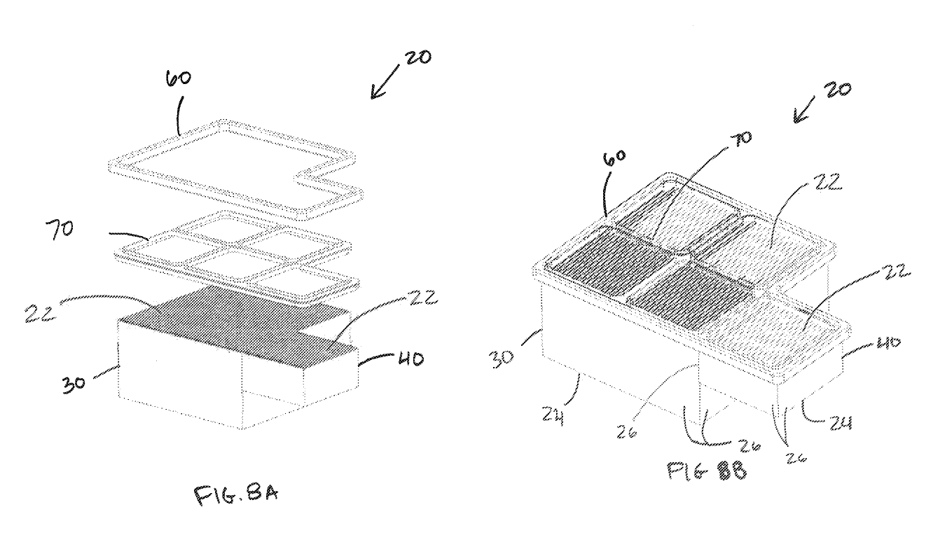

The seal 60 may be configured and shaped according to the shapes or cross-sectional areas of the first and second media packs 30 and 40, according to the desired configuration. According to another embodiment as shown in FIGS. 5-6, the seal 60 may extend in different amounts beyond an outer edge of the filter element 20 (e.g., beyond an outer edge of the first and second media packs 30 and 40 attached to each other) around the perimeter of the filter element 20. Accordingly, the seal 20 may extend further from an edge of the filter element 20 in particular areas of the perimeter (compared to other areas of the perimeter) in order to shape an inlet or outlet face of the filter element 20 or to provide an area for attachment to the filter element 20. According to another embodiment as shown in FIG. 7, the seal 60 may extend approximately evenly beyond an outer edge of the filter element 20 around the perimeter of the filter element 20.

The seal 60 may be located anywhere along the filter element 20. For example, the seal 60 may be positioned around or attached to the inlet face 22 and/or the outlet face 24 of each of the first and second media packs 30 and 40.

### The Reinforcing Frame

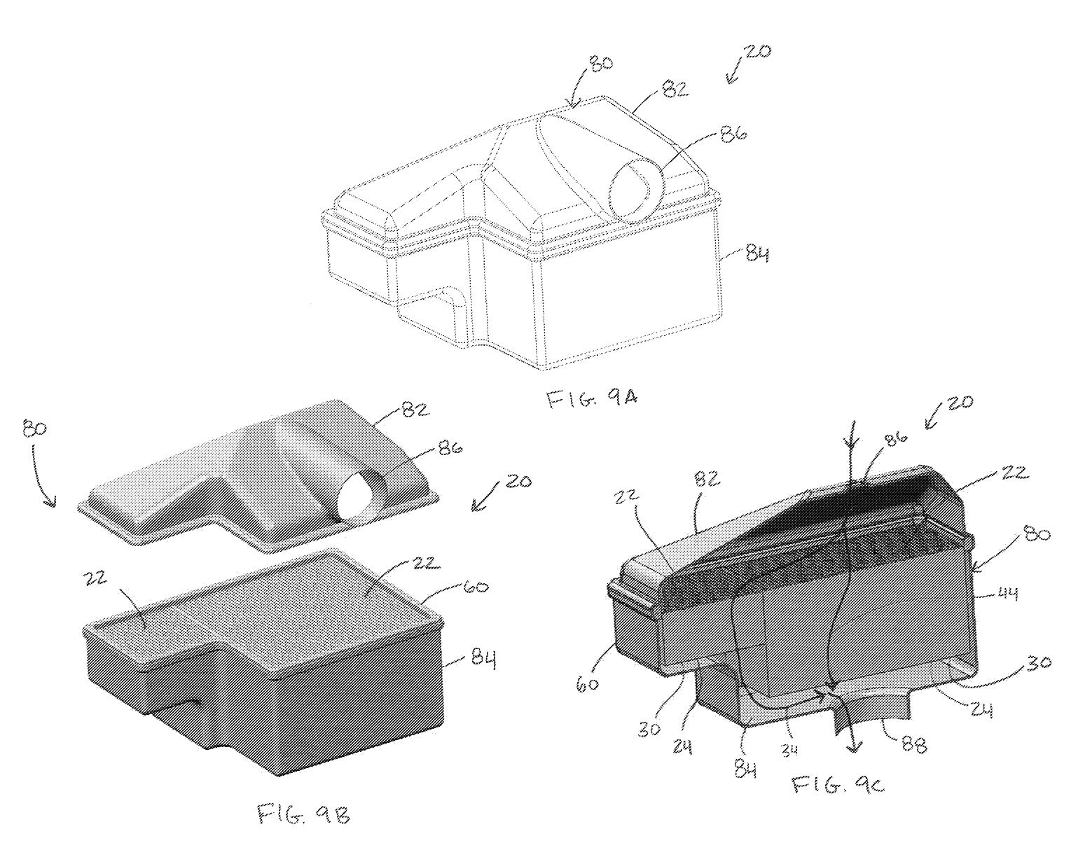

According to another embodiment, the filter element 20 may further include a support or reinforcing frame 70 that may reinforce certain areas of the filter element 20 as shown in FIGS. 8A-8B. The seal 60 may optionally be used with the frame 70 to separate or direct the fluid flow between the first and second media packs 30 and 40. The reinforcing frame 70 may further divide at least a surface of the filter element 20 (e.g., the inlet face 22 and/or the outlet face 24) into different areas or sections according to the desired configuration and/or for additional support.

At least one of the first and second media packs 30 or 40 may be adhered to or potted into the reinforcing frame 70. As shown in FIGS. 8A-8B, the reinforcing frame 70 may be positioned between the seal 60 and the inlet faces 22 and/or the outlet faces 24 or the first and second media packs 30 and 40. The outside perimeter of the reinforcing frame 70 may generally follow the outside perimeter of the seal 60 and the outside perimeter of the first and second media packs 30 and 40 together. However, it is anticipated that the reinforcing frame 70 may be positioned anywhere along the filter element 20 and may not directly correspond to where the seal 60 is attached, according to the desired configuration.

The reinforcing frame 70 may be constructed out of a variety of materials. For example, the reinforcing frame 70 material may be a polymer.

### The Housing

According to yet another embodiment as shown in FIGS. 9A-9C, the filter element 20 may include a frame or housing 80 order to provide structural integrity around the first and second media packs 30 and 40. The housing 80 may be molded into unique shapes to correspond to and contain the first and second media packs 30 and 40 and to fit within the space constraints of the entire filter element 20.

The housing 80 may include a compartment 84 to hold at least a portion of the first and second media packs 30 and 40 and a lid 82 to seal the housing 80 and direct the flow. The housing 80 may also include at least one inlet 86 and at least one outlet 88 to allow the air or fluid to flow through and thus into and from the first and second media packs 30 and 40 (although it is anticipated that the inlet 86 and outlet 88 may be reversed). As shown in FIG. 9C, the housing 80 may attach to a portion of the seal 60 (or the reinforcing frame 70).

The housing 80 may be constructed out of a variety of materials. For example, the housing 80 material may be a polymeric housing 80.

According to one embodiment as shown in FIGS. 11A and 9C, the first and second media packs 30 and 40 may be positioned within the housing 80 such that the first flow path 34 and the second flow path 44 may diverge from each other after flowing or entering through the inlet 86 of the housing 80 in order to flow the first media pack 30 and the second media pack 40, respectively. Subsequently, the first and second flow paths 34 and 44 may converge together before flowing or exiting through the outlet 88 of the housing 80.

According to another embodiment, the first and second media packs 30 and 40 may be arranged in a configuration similar to that of FIG. 11B. Accordingly, the first and second media packs 30 and 40 may be positioned within the housing 80 such that the fluid flows through the inlet 86 of the housing 80 and directly into the first filter media 30 along the first flow path 34. Subsequently, the fluid may change direction (due to, for example, a wall of the housing 80) and flow through the second filter media 40 along the second flow path 44. The fluid may subsequently flow through the outlet 88 of the housing 80.

In order to construct or create the filter element 20, the first and second media packs 30 and 40 may be produced and assembled as individual modules. The first and second media packs 30 and 40 may then be arranged into the desired configuration relative to each other. Once the first and second media packs 30 and 40 have been properly arranged, the first and second media packs 30 and 40 may be sealed into one block (e.g., into the filter element 20) with the seal 60. This construction method simplifies manufacturing, reduces waste, and does not involve or significantly minimizes cutting or scrapping off a portion of the media packs.

It is understood that the various components, configurations, and features of the different embodiments of the filter element 20 may be combined according to the desired use and configuration.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. A filter element, comprising:
a first filter media pack with a first media pack inlet face and a first media pack outlet face; and
a second filter media pack with a second media pack inlet face and a second media pack outlet face, the second filter media pack being formed separately from the first filter media pack and coupled to the first filter media pack such that the first media pack inlet face and the first media pack outlet face do not overlap with the second media pack inlet face and the second media pack outlet face, respectively,
wherein the first filter media pack and the second filter media pack each include a corresponding filter media pack characteristic, and wherein the filter media pack characteristic of the first filter media pack is different from the corresponding filter media pack characteristic of the second filter media pack so as to substantially equalize flow between the first filter media pack and the second filter media pack.

2. The filter element of claim 1, wherein the corresponding filter media pack characteristic comprises at least one of a length, a width, and a height of the first filter media pack and the second filter media pack.

3. The filter element of claim 1, wherein the corresponding filter media pack characteristic comprises a shape of the first and the second filter media packs.

4. The filter element of claim 3, wherein the shape of each of the first and second filter media refers to an outer shape of each of the first and second filter media.

5. The filter element of claim 1, wherein the corresponding filter media pack characteristic comprises a media density of the first filter media pack and the second filter media pack.

6. The filter element of claim 1, wherein the corresponding filter media pack characteristic comprises a layer spacing of the first filter media pack and the second filter media pack.

7. The filter element of claim 1, wherein the corresponding filter media pack characteristic comprises a material composition of a first filter media of the first filter media pack and of a second filter media of the second filter media pack.

8. The filter element of claim 1, wherein the corresponding filter media pack characteristic comprises a pleat bend angle of the first filter media pack and the second filter media pack.

9. The filter element of claim 1, wherein the corresponding filter media pack characteristic comprises a pleat density of the first filter media pack and the second filter media pack.

10. The filter element of claim 1, wherein the first media pack has a higher height and a lower media density than the second media pack.

11. The filter element of claim 1, wherein the first filter media pack and the second filter media pack are in a side-by-side configuration.

12. The filter element of claim 1, further comprising a third filter media pack that is formed separately from the first media pack and the second media pack, wherein the third filter media pack is coupled to at least one of the first media pack and the second media pack and includes a corresponding filter media pack characteristic to the first filter media pack and the second filter media pack, wherein the filter media pack characteristic of the third filter media pack is different from the corresponding filter media pack characteristics of at least one of the first filter media pack and the second filter media pack.

13. The filter element of claim 1, wherein a first filter media pack side face of the first filter media pack and a second filter media pack side face of the second filter media pack directly abut each other.

14. The filter element of claim 1, wherein at least one of a frame and a seal couples the first filter media pack and the second filter media pack together.

15. The filter element of claim 14, wherein at least one of the frame and the seal separates a first flow path of the first filter media pack and a second flow path of the second filter media pack.

16. The filter element of claim 14, further comprising a gap between a first filter media pack side face of the first filter media pack and a second filter media pack side face of the second filter media pack.

17. The filter element of claim 1, wherein the first filter media pack includes at least one first filter media pack side face extending between the first filter media pack inlet face and the first filter media pack outlet face and defines a first flow path, wherein the second filter media pack includes at least one second filter media pack side face extending between the second filter media pack inlet face and the second filter media pack outlet face and defines a second flow path, wherein the first filter media pack and the second filter media pack are coupled together such that the at least one first filter media pack side face is positioned next to the at least one second filter media pack side face and the first flow path is not aligned with the second flow path.

18. The filter element of claim 17, wherein first filter media pack and the second filter media pack are positioned together in a housing with an inlet and an outlet, wherein the first flow path and the second flow path diverge from each other after the inlet and converge together before the outlet.

19. The filter element of claim 17, wherein the first flow path flows into the second flow path, wherein the first flow path and the second flow path are in substantially opposite directions.

20. A filter element configured to filter a fluid comprising:
a first filter media pack with a first filter media pack inlet face, a first filter media pack outlet face, and at least one first filter media pack side face extending between the first filter media pack inlet face and the first filter media pack outlet face, the first filter media pack defining a first flow path; and
a second filter media pack with a second filter media pack inlet face, a second filter media pack outlet face, and at least one second filter media pack side face extending between the second filter media pack inlet face and the second filter media pack outlet face, the second filter media pack defining a second flow path,
the first filter media pack and the second filter media pack being formed separately from each other and coupled together such that the at least one first filter media pack side face is positioned next to the at least one second filter media pack side face of the second filter media pack and the first flow path is not aligned with the second flow path,
wherein flow through the first filter media pack and the second filter media pack is substantially equal.

21. The filter element of claim 20, wherein the first filter media pack and the second filter media pack each include a corresponding filter media pack characteristic, and wherein the filter media pack characteristic of the first filter media pack is different from the corresponding filter media pack characteristic of the second filter media pack.

22. The filter element of claim 20, wherein first filter media pack and the second filter media pack are positioned together in a housing with an inlet and an outlet, wherein the first flow path and the second flow path diverge from each other after the inlet and converge together before the outlet.

23. The filter element of claim 20, wherein the first flow path flows into the second flow path, wherein the first flow path and the second flow path are in substantially opposite directions.
